(19) United States
(12) Patent Application Publication
(10) Pub. No.: US 2012/0128246 A1
(43) Pub. Date: May 24, 2012

(54) METHODS AND SYSTEMS FOR COLOR MANAGEMENT IN DISPLAY SYSTEMS

(75) Inventors: Long YANG, Union City, CA (US); Julia FAUCHILLE, San Francisco, CA (US); Conrad DANTE, Oceanside, CA (US); Charles Melvin ADEN, Berkeley, CA (US)

(73) Assignees: High Definition Integration, LTD, Grand Cayman (KY); ROSSELLA LIMITED, Tortola (VG)

(21) Appl. No.: 13/363,209

(22) Filed: Jan. 31, 2012

Related U.S. Application Data
(62) Division of application No. 12/215,782, filed on Jun. 27, 2008.

(51) Int. Cl. G06K 9/00

(52) U.S. Cl. 382/167

(57) ABSTRACT

A method of processing an input image includes receiving an input signal associated with the input image. The input signal includes a plurality of components. The method also includes determining a minimum component of the plurality of components and determining a white signal level as a function of the minimum component. The method further includes multiplying the white signal level by a normalized value computed using a component of the plurality of components to provide a scaled white signal level.

### CROSS-REFERENCES TO RELATED APPLICATIONS

The present application claims benefit under 35 U.S.C. §119(e) of U.S. Provisional Patent Application No. 60/947,356, filed on Jun. 29, 2007, entitled “Methods and Systems for Color Management in Displays,” the disclosure of which is hereby incorporated by reference in its entirety for all purposes.

### BACKGROUND OF THE INVENTION

The present invention relates generally to the field of image processing. More particularly, the present invention relates to methods and apparatus for enhancing the brightness of images displayed using display systems. Merely by way of example, the method and apparatus of the present invention are used to enhance the brightness of an image using a white color segment of a color wheel with little or no reduction of the color gamut associated with the primary colors of the display system and without degrading color perception. The method and apparatus can be applied to a variety of display systems, including liquid crystal displays, projection displays, plasma displays, and color sequential displays.

Active matrix displays, passive liquid crystal displays, plasma displays, and the like are examples of flat panel displays that are commonly used for computers, televisions, monitors, watches, video cameras, PDAs, telephones, and the like. The basics of the color science of human vision include color perception. On the retina of human eyes, there are three kinds of light sensitive nerve (cones) which have three different spectral responses. When the cones detect light, they generate electrical signals to the nervous system. From the relative strengths of these three signals, different colors are perceived. Thus, in display applications, the reproduction of color does not generally attempt to reproduce the original spectrum, but to reproduce the relative signals generated by the cones.

In many display systems, three primary light sources are used to generate color images. Color gamut is a term used to describe the range of the colors which can be generated by the combination of the three primary light sources. FIG. 1 illustrates the CIE 1931 color space chromaticity diagram. All human perceivable color has a unique color coordinate, x-y. The outer boundary of the dome shape is formed by the coordinate of colors with a very narrow spectral width.

FIG. 1 also shows a triangle. The vertices of the triangle are the so-called “primary colors” of the display. The wider the separation between these three primary colors, the larger the area of the triangle is, thus the larger the color gamut. As seen in FIG. 1, with three primary colors, most, but not all the possible colors can be generated.

There are a number of approaches to enlarge the color gamut to provide more vivid color reproductions. Typically, in LCD displays or color-sequential projection display, the light sources used in the display system are white. Color filters are generally used to remove some transmission of light in certain wavelengths and thereby produce the primary colors. For example, the red primary color (R) typically has wavelengths ranging from 600 nm to 650 nm; the green primary color (G) typically has wavelengths ranging from 500 nm to 560 nm; and the blue primary color (B) typically has wavelengths ranging from 420 nm to 500 nm. The sum of the appropriate ratio of R. G, and B will produce a white color with a so-called “correlated color temperature” defined by the black body radiation. Such a white color is referred to herein as “W₃=R+G +B,” where “3” refers to a combination of the three primary colors.

In addition to three primary color filters, sonic one-chip display systems have utilized an additional portion of a color wheel to pass unfiltered light, which may be referred to as a “white” color filter or white segment. Such a white filter would ideally pass as much light as possible and is referred to as “W₁,” wherein “1” refers one single light source. Because the spectral bandwidth passed by a white filter segment is much larger than the red, green, and blue filters, the intensity passed by a white segment could significantly increase.

If a white segment is introduced as a color for the display in addition to the three primary colors, the addition of the white light from the white segment will move the color coordinate toward the center of the chromaticity diagram, and therefore, reduce the color saturation. In some of these conventional systems, the amount of white light added to the input signal is based on the overall luminance of the input signal. These systems effectively superimpose a black and white signal on top of the color image. Some display systems use this approach, for example, in data projectors, where the advantages provided by higher image brightness outweigh the disadvantages associated with reduced color saturation.

Therefore, there is a need in the art for improved methods and systems for enhancing the brightness of images in display systems without degrading color perception.

### SUMMARY OF THE INVENTION

According to embodiments of the present invention, methods and systems related to the field of image processing are provided. More particularly, the present invention relates to methods and apparatus for enhancing the brightness of images displayed using display systems. Merely by way of example, the method and apparatus of the present invention are used to enhance the brightness of an image using a white color segment of a color wheel with no reduction of the color gamut associated with the primary colors of the display system and without degrading color perception. The method and apparatus can be applied to a variety of display systems, including liquid crystal displays, projection displays, plasma displays, and color sequential displays.

According to a specific embodiment of the present invention, a method of processing, an input image is provided. The method includes receiving an input signal associated with the input image. The input signal includes a plurality of components. The method also includes determining a minimum component of the plurality of components and determining a white signal level as a function of the minimum component. The method further includes multiplying the white signal level by a normalized value computed using a component of the plurality of components to provide a scaled white signal level.

According to a particular embodiment of the present invention, an apparatus configured to perform image processing is provided. The apparatus includes a plurality of input ports configured to receive a plurality of components of an image and a first look-up table configured to provide a function of a first component of the plurality of components. The apparatus also includes a second look-up table configured to provide functions of a second and a third component and a processor coupled to the plurality of input ports and configured to compute a minimum of the plurality of components. The apparatus further includes a plurality of color correction look-up tables. Each of the plurality of color correction tables is configured to perform color correction for each of the plurality of components. Moreover, the apparatus includes a plurality of adders coupled to the plurality of color correction look-up tables and the plurality of input ports, a plurality of output ports coupled to the adders and configured to output adjusted components, and a selector coupled to the processor and configured to output a white level signal.

According to another embodiment of the present invention, an apparatus for processing an RGB image is provided. The apparatus includes a green input port configured to receive a green component of the RGB image, a red input port configured to receive a red component of the RGB image, and a blue input port configured to receive a blue component of the RGB image. The apparatus also includes a first look-up table coupled to the green input port and a second look-up table coupled to the red input port and the blue input port. The apparatus further includes a processor coupled to the green input port, the red input port, and the blue input port. The processor is configured to compute a minimum of the green component, the red component, and the blue component. The apparatus additionally includes a set of multipliers coupled to the second look-up table and to the green input port and a selector coupled to the first look-up table and the set of multipliers. The selector is configured to receive the minimum of the green component, the red component, and the blue component as an input and output a white level signal. Moreover, the apparatus includes a green color correction look-up table coupled to the first look-up table, a red color correction look-up table coupled to a first multiplier of the set of multipliers, and a blue color correction look-up table coupled to a second multiplier of the set of multipliers. Furthermore, the apparatus includes a second set of multipliers. Each of the second set of multipliers is coupled to one of the green, red, or blue color correction look-up tables and the white level signal. Additionally, the apparatus includes a set of adders. Each of the adders is coupled to one of the second set of multipliers and one of the green, red, or blue input ports.

Many benefits are achieved by way of the present invention over conventional techniques. For example, embodiments of the present invention provide methods and systems that increase the brightness of a display system, while preserving color saturation of skin tones and minimizing noticeable video compression artifacts caused by brightness increments. Moreover, embodiments of the present invention operate in RGB gamma-encoded space, which allows for efficient management of electronics resources. Furthermore, several adjustable parameters are provided by embodiments that enable optimization of the video experience. Depending upon the embodiment, one or more of these benefits, as well as other benefits, may be achieved. These and other benefits will be described in more detail throughout the present specification and more particularly below in conjunction with the following drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates the CIE 1931 color space chromaticity diagram;

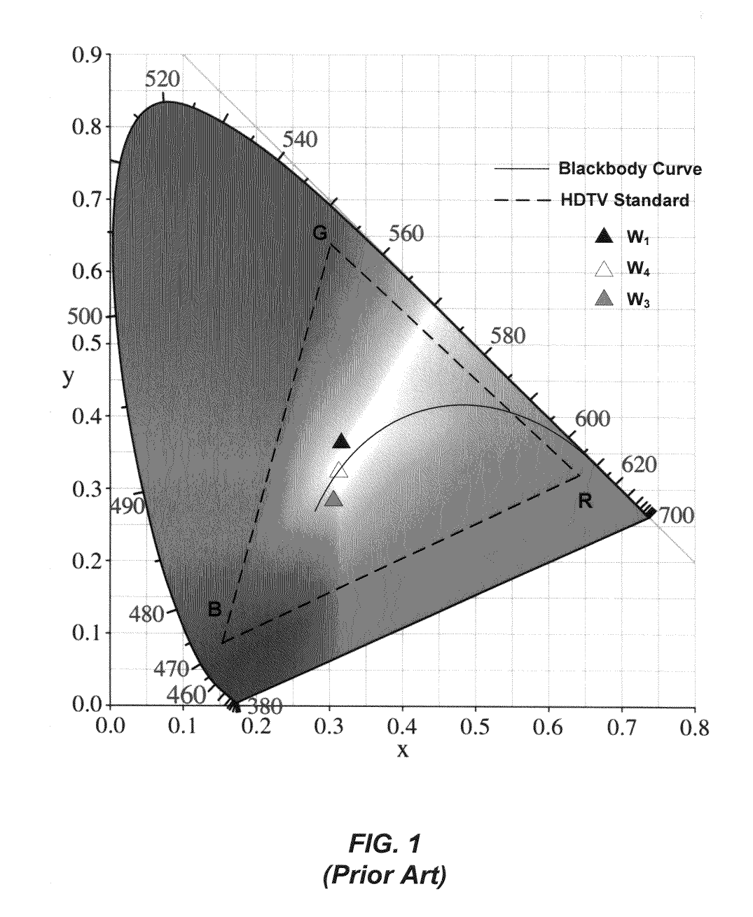

FIG. 2 is a simplified plot of a normalized white level signal computed as a function of a minimum RGB signal;

FIG. 3 is a simplified plot of a function h(x) according to an embodiment of the present invention;

FIG. 4 is a simplified plot of a white level signal as a function of the minimum RGB component and the men component according to an embodiment of the present invention;

FIG. 5 is a simplified two-dimensional plot of a white level signal as a function of the minimum RGB component for several values of the green component according to an embodiment of the present invention;

FIGS. 6A-6C illustrate color palettes for exemplary bright backgrounds according to an embodiment of the present invention;

FIG. 7 is a simplified plot of normalized intensity as a function of gray level according to an embodiment of the present invention;

FIGS. 8A-8C illustrate results of the simulation of exemplary skin tones according to an embodiment of the present invention;

FIG. 9 is a simplified schematic diagram illustrating an implementation of an embodiment of the present invention; and

FIG. 10 is a simplified flowchart illustrating a method of providing an output image for a display according to an embodiment of the present invention.

### DETAILED DESCRIPTION OF SPECIFIC EMBODIMENTS

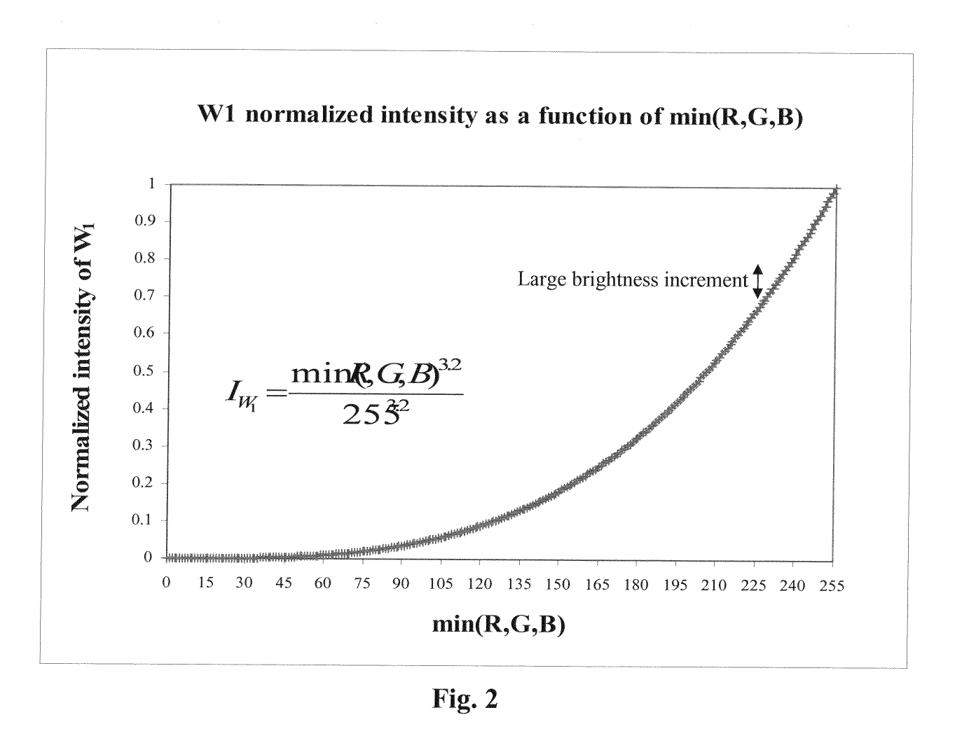

Some display systems, in order to increase the brightness of displayed images, have added a white level signal to an input RGB signal. FIG. 2 is a simplified plot of a normalized white level signal computed as a function of a minimum RGB signal. Such an algorithm selectively adds a white level signal to a video signal to achieve higher brightness for bright colors. In this algorithm, little or no white level adjustment is added for saturated colors, while a full strength of white level is added if the input color is near the white point. To achieve these effects, the white component is a function of the minimum of the incoming red, green, and blue pixel components (min(R,G,B)). A nonlinear progression of white is added in between the two regimes of fully-saturated (i.e., min(R,G,B)=0) and pure white (i.e., min(R,G,B)=255). Thus, the white level signal added to the RGB signal is null in the dark region and increases very rapidly for the bright scenes, resulting in larger steps of brightness for bright scenes than those associated with the original signal.

It was observed that in some situations, this rapid rate of white addition in bright scenes enhances the contouring artifacts of highly compressed video with a near-uniform background. In a bright, uniform background, the red, green, and blue signals are all large, therefore, the minimum of red, green, and blue is also large, resulting in a correspondingly large contribution to the white component. Since video compression algorithms usually operate within blocks (e.g., 8×8 pixels), slight variations of the minimum of red, green, and blue typically exist between adjacent blocks. However, when the white level signal computed using FIG. 2 is added to these adjacent pixel blocks, the difference in the brightness of the white level signals in adjacent blocks can be large due to the large slope of the white level signal curve as the minimum of the red, green, and blue components reaches large values. This brightness difference may be observable to a viewer and may appear as a color difference. In playback video, this effect often appears as a shimmer of bright compression blocks.

The accurate rendering of skin tones presents challenges in video display applications. Skin tones are complex textures to render because they include a patchwork of colors that cover a large palette of yellow, purple, red, pink, brown and other colors, with intensities varying from dark to full white. To maintain the rendering of such textures and the color aspect of the skin, it is useful to control the color saturation in regions of the chromaticity diagram corresponding to skin tones.

Although the addition of a white level signal as illustrated in FIG. 2 provides brightness enhancement, it was observed that skin tones may appeared desaturated. In order to increase the color saturation in the mid-level range of brightness, which is generally associated with skin tones, embodiments of the present invention provide brightness enhancement, color correction, and/or gamma correction as described more fully throughout the present specification. For example, color correction is used herein to compensate for one or more effects resulting from the addition of a white level signal to colors and/or intensities associated with skin tones.

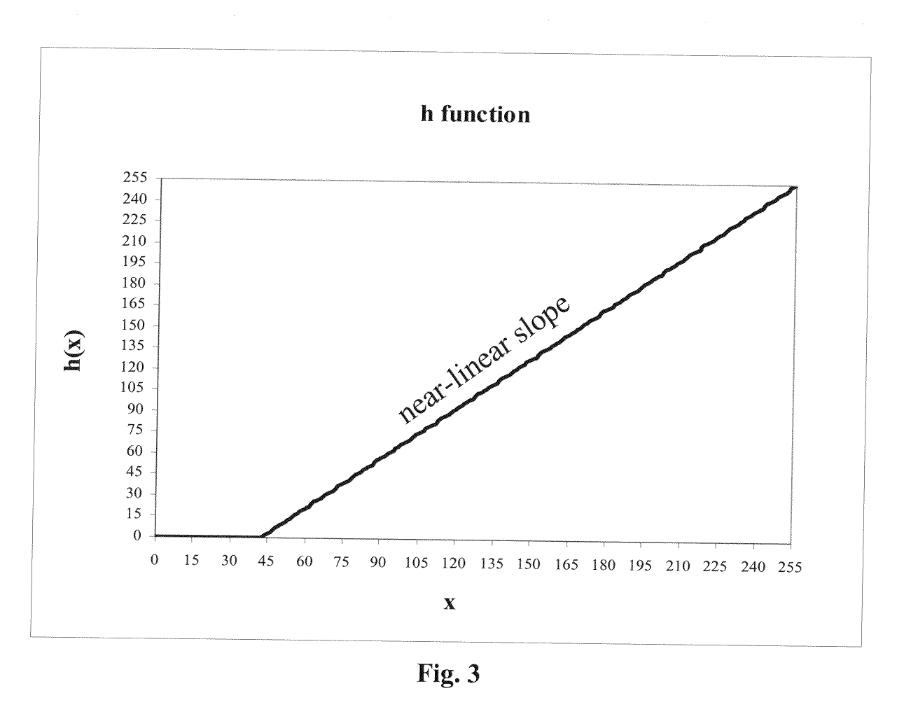

FIG. 3 is a simplified plot of a function h(x) according to an embodiment of the present invention. According to embodiments of the present invention, the addition of a white level signal to the input signal is computed in a series of steps. Referring to FIG. 3, a function h(x) is computed as a function of an input variable x. Although FIG. 3 illustrates a particular function, embodiments of the present invention are not limited by the function illustrated in FIG. 3, which merely provides an exemplary function to illustrate embodiments described herein.

In FIG. 3, h(x) is defined as:

$$h ( x ) = \{ \begin{matrix}0 & if x < a \\ m ( x - a ) & if x > a ,\end{matrix} \qquad ( 1 )$$

where in is the slope of the h(x) curve for values of x>a. The parameter a, which defines the threshold, and the slope in are user adjustable parameters as described more fully below.

As illustrated in FIG. 3, h(x) is characterized by a threshold at the value x=a. This threshold, among other benefits, serves to preserve saturated colors having low intensity levels. Additionally, as illustrated by equation (1), the slope of h(x) for values greater than the threshold is linear, providing steady incremental adjustments in the high brightness region. As a result, the addition of large increments in the white level signal as a function of input color intensity is avoided. Although FIG. 3 illustrates a linear function above the threshold, other functions are included within the scope of embodiments of the present invention, including nearly-linear functions, non-linear functions, and the like.

In a particular, embodiment, an efficient electronics solution is used to implement the function illustrated in FIG. 3 as a look-up table of integers from 0 to the maximum component value (typically 255, 511, 1023, or the like). In one embodiment, the look-up table approximates a piece-wise linear function corresponding to the two properties of the function h(x) described above. In other embodiments, functions embedded in one or more memories or electronics are utilized to implement the illustrated function.

In many HDTV display systems, red, green, and blue digital signals are used to form the RGB color space. In the examples described herein, an 8-bit color depth representing 256 levels (0 to 255) is utilized, although this is not required by embodiments of the present invention.

Embodiments of the present invention add a white level signal (alternatively referred to as a white level adjustment) to the input signal, for example an RGB signal. The white level signal, W₁, is computed as:

$${W}_{1} = {W}_{0} \cdot \frac{G}{255} = h ( min ( R , G , B ) ) \cdot \frac{G}{255} , \qquad ( 2 )$$

where W₀=h(min(R, G, B)) is the minimum value of the three input component signals and (G/255) is a scaling factor. The signal W₁ is rounded to form an integer from 0 to 255 in some embodiments.

Discussion of functions used to compute h(min(R, G, B)) and min(R, G. B) are discussed in additional detail in co-pending and commonly assigned U.S. Provisional Patent Application No. 60/947,355, entitled “METHODS AND SYSTEMS FOR BRIGHTNESS ENHANCEMENT IN DISPLAYS,” filed on Jun. 29, 2006, the disclosure of which is incorporated herein by reference in its entirety for all purposes.

Referring to FIG. 3, in the mid-level region of the h(x) function (e.g., x≈128), the amount of white level signal W₁ computed using the h(x) function is relatively large due to the linear behavior of the h(x) function. In order to further refine the white level signal, the scaling factor (G/255) is utilized in computing W₁ as described more fully below.

Since human eyes are most sensitive to green colors, the dominant contributor to image brightness is the green component in an RGB signal. As a result, the overall brightness of an image is largely determined by the amount of green content in the image. Accordingly, embodiments of the present invention approximate the brightness of the image by the strength of the green component. Thus, the normalized green component serves as a proxy for image brightness. Among other benefits, scaling by the normalized green component reduces the white signal level added in the mid-level region.

It is possible that embodiments of the present invention could scale the white signal level W₁ by the actual brightness of the image, but in order to reduce computational complexity, the green component is used as a proxy for brightness. The inventors have determined that the benefits provided by this approximation outweigh the marginal benefits provided using more complex computations including the actual brightness.

The normalized scaling factor G/255 in equation (2) reduces the amount of W₁ added when G is small, i.e., when the image is dim. Conversely, when the image is bright, the full strength of white addition is used. As a result, this simple scaling factor allows adding an additional white signal level W₁ as a function of the approximate image brightness. Although the scaling factor of G/255 is utilized in equation (2), the present invention is not limited to this particular scaling factor since other scaling factors including other quantities or functions may be utilized depending on the particular application. Merely by way of example, a function that may be utilized is (0.2*R+0.7*G+0.1*B)/255. Other functions including other weighting coefficients for each of the components may also be utilized. Generally, the green component will receive the highest weighting coefficient since it is the dominant contributor to image brightness in an RGB signal. One of ordinary skill in the art would recognize many variations, modifications, and alternatives.

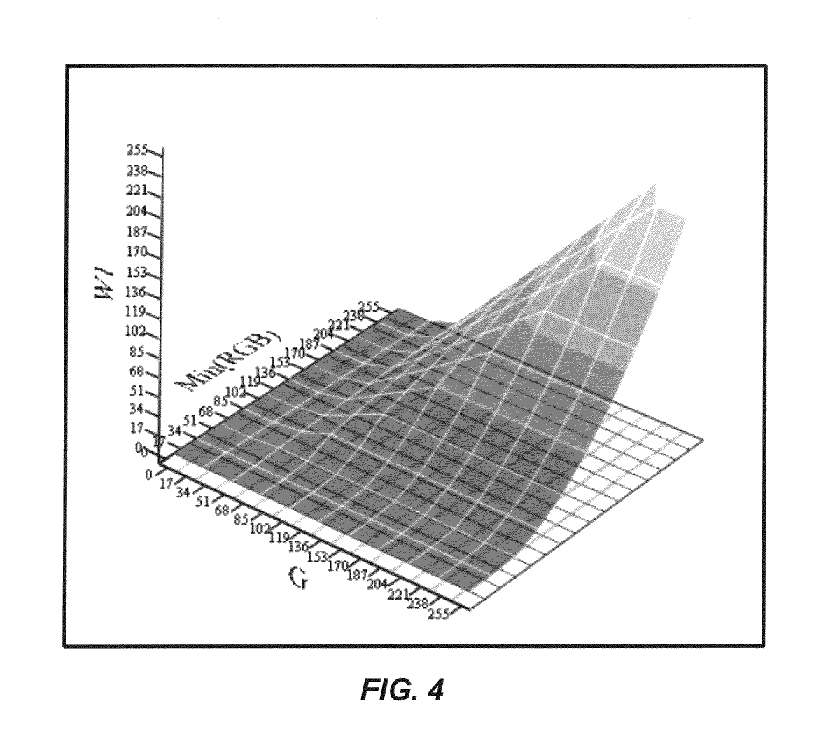

FIG. 4 is a simplified plot of a white level signal as a function of the minimum RGB component and the green component according to an embodiment of the present invention. As illustrated in FIG. 4, as the strength of the green component decreases, the amount of white level signal added decreases linearly. When the strength of the green signal is less than the strength of the corresponding red and blue signals, i.e. when G is the minimum of the three components, the amount of white level signal added is proportional to the square of the green component (i.e., W₁∝G²).

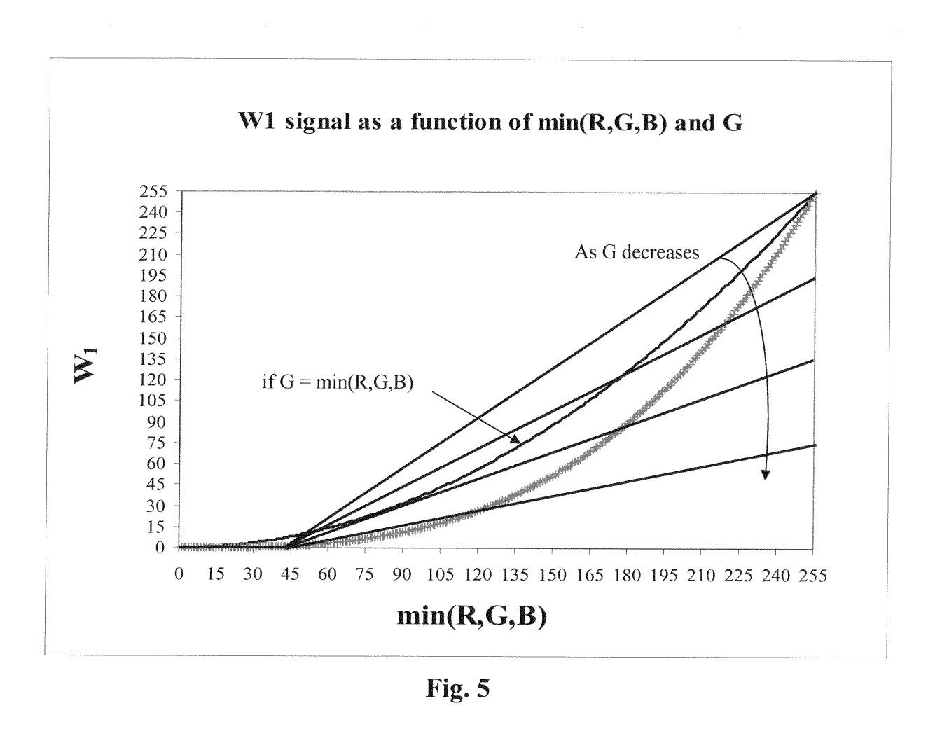

FIG. 5 is a set of simplified two-dimensional plots of the white level signal W1 as a function of the minimum RGB component for several values of the green component according to an embodiment of the present invention. The strikethrough line in FIG. 5 represents a white level signal with a non-linear dependence on min(R, G, B). If the function h varies quadratically instead of linearly as a function of min(RGB), the scaling by the normalized green component may result in a function proportional to the cube of the green component intensity. As a result, near full white, the local increases in white level signal as a function of min(R, G, B) are large enough to produce shimmering of the image.

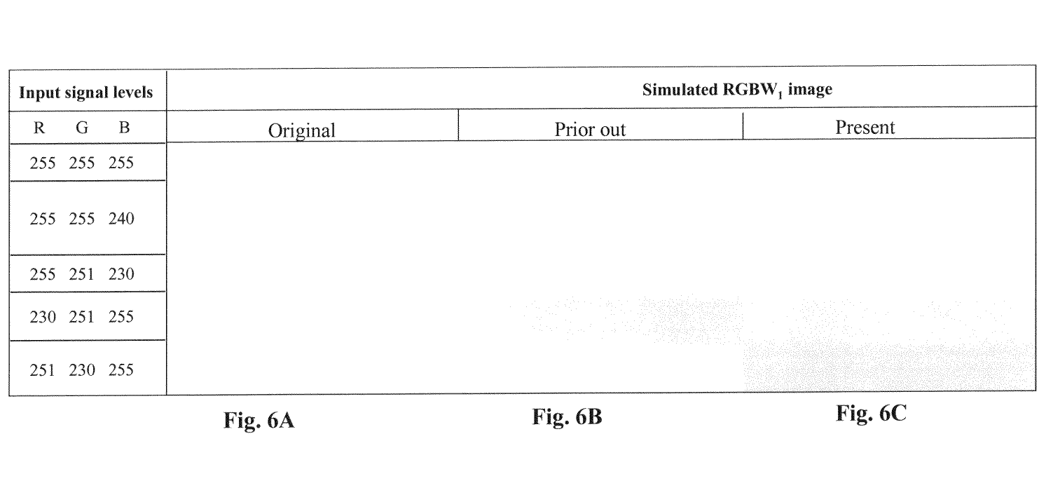

In order to illustrate the advantage of using the linear h(x) function illustrated in FIG. 3, an RGB image was created with bands of pastel colors. FIGS. 6A-6C illustrate color palettes for exemplary bright backgrounds according to an embodiment of the present invention. FIG. 6A illustrates an original image with RGB components ranging from 200 to 255, which simulates a scene with a bright background. FIG. 6B illustrates a color corrected image computed by adding the white signal level computing using the function illustrated in FIG. 2 to the RGB signal illustrated in FIG. 6A. The RGBW₁ image illustrated in FIG. 6B exhibits large brightness steps between color bands, which results in noticeable color distortion. FIG. 6C illustrates a color corrected image computed using a white signal level computed using equation (2). The RGBW₁ image illustrated in FIG. 6C was computed using a slope parameter of m=1.2 and exhibits significantly reduced color distortion artifacts. Without limiting embodiments of the present invention, the inventors credit this reduction in distortion to the slow rate at which the white signal level is added for input signals having high min(R, G, B) levels.

As illustrated in FIG. 6C, in the mid-levels of min(R, G, B), the addition of white signal level is still large, even after being scaled by the normalized green component. This may contribute to desaturation of the colors belonging to this mid-level region. Since skin tones cover a large palette of color and brightness and achieving color saturation for such skin tones is desirable, embodiments of the present invention limit the addition of white signal level in the mid-levels of min(R, G, B) to increase color saturation.

Embodiments utilize a color correction algorithm in which the complementary color to an input RGB signal is subtracted from the input signal. Accordingly, the effects of desaturation of color in mid-range brightness levels, which results from the addition of the white level signal, is reduced. Three functions are defined as follows:

$${W}_{R}^{′} = h ( R ) \cdot \frac{G}{255} \\ {W}_{G}^{′} = h ( G ) \cdot \frac{G}{255} \\ {W}_{B}^{′} = h ( B ) \cdot \frac{G}{255} . \qquad ( 3 )$$

Color correction is provided by subtracting a quantity δR, δG, and δB from the respective components of the input RGB signal as illustrated in equation (4). For each component, a parameter representing the color correction amplitude α_{R}, α_{G}, and α_{B}, is used to modulate the amount of color correction for the component. The resulting primary color values after color correction arc referred to as R′, G′, and B′ as shown in equation (4). The final image suitable for display (e.g., R′G′B′W₁) is computed using the above equations as well as:

$${R}^{′} = R - \underbrace{{α}_{R} ( {W}_{1} ( 1 - \frac{{W}_{R}^{′}}{255} ) )}_{δ R} \\ {G}^{′} = G - \underbrace{{α}_{G} ( {W}_{1} ( 1 - \frac{{W}_{G}^{′}}{255} ) )}_{δ G} \\ {B}^{′} = B - \underbrace{{α}_{B} ( {W}_{1} ( 1 - \frac{{W}_{B}^{′}}{255} ) )}_{ δ B} , \qquad ( 4 )$$

In an embodiment, the color correction amplitude α, which is a user adjustable parameter, is set to:

α=α_{R}=α_{G}=α_{B}. (5)

The equality of the α components defined in equation (5) provides for identical color correction for all colors of the same hue. As a result, embodiments of the present invention conserve the gray digital balance while performing color correction to increase the color saturation without modifying the color balance with respect to gray.

To illustrate an embodiment of the present invention, the following example of color correction is provided. This example is merely provided to illustrate the benefits provided herein and is not intended to limit embodiments described throughout the present specification. In this example, for a particular image, a pixel has components R=G=B=128, which corresponds to a mid-gray. Preferably, the color correction for this shade of gray is a maximum. If α=1 and m=1, W₁=W_{R}=W_{G}=W_{B}=64 and δR =δG=δB=48. Referring once again to FIG. 2, it will be noted that because h(255)=255, given the slope m, the threshold point α can be computed as needed. From equation (4), R′=G′=B′=128−48=80, which is also associated with a gray level. In order to provide an output signal, the color corrected values R′, G′, and B′ are utilized along with the scaled white signal level W₁ (i.e., R′G′B′W₁).

The output to the display includes not only the white signal level, which is scaled by the normalized green component (a proxy for the brightness of the image), but the color corrected values for the individual components. As a result, embodiments reduce contouring by providing a white level signal that is linear or near-linear with gray level, scaling the white level signal by the green component/brightness, and providing color correction to increase color saturation while preserving the color balance of gray.

Referring to equation (4), color correction as provided herein results in zero color correction at full black and full white. When W₁ is null, i.e., when the color is fully saturated or black, the color correction is null (i.e., δR=δG=δB=0) and R′, G′, and B′ are equal to R, G, and B, respectively. When W₁ is a maximum value (e.g., W₁=255), the color correction is also null since δR=δG=δB=0. As a result, at maximum brightness, full white is conserved.

As described throughout the present specification, advantages provided by embodiments of the present invention include two new levers for tuning the image: (1) by adjusting the slope of the curve for white addition (m) during the brightness enhancement process, and (2) by controlling the color correction amplitude (α) for the primary color components as utilized in equation (4) during the color correction process.

Color saturation may be increased through the use of a scaling process upstream of other image processing tasks as described herein. This scaling process is also referred to as a gamma correction process. For example, in some embodiments, calibration of the display may be performed to increase the color saturation of the previously computed R′, G′, B′, and W₁ components. In order to conserve the linear progression of white, the gamma correction applied to the white signal W₁ in some embodiments is close to a linear gamma. At the same time, in order to achieve high primary color saturation during the display calibration process, the gamma correction applied to the R′, G′, and B′ signals can be customized and set at a level different or different levels from the gamma correction applied to W₁. By increasing the saturation of the primary colors after the other image processing tasks described herein (e.g., brightness enhancement and color correction), reductions in color distortion in the final image are achieved.

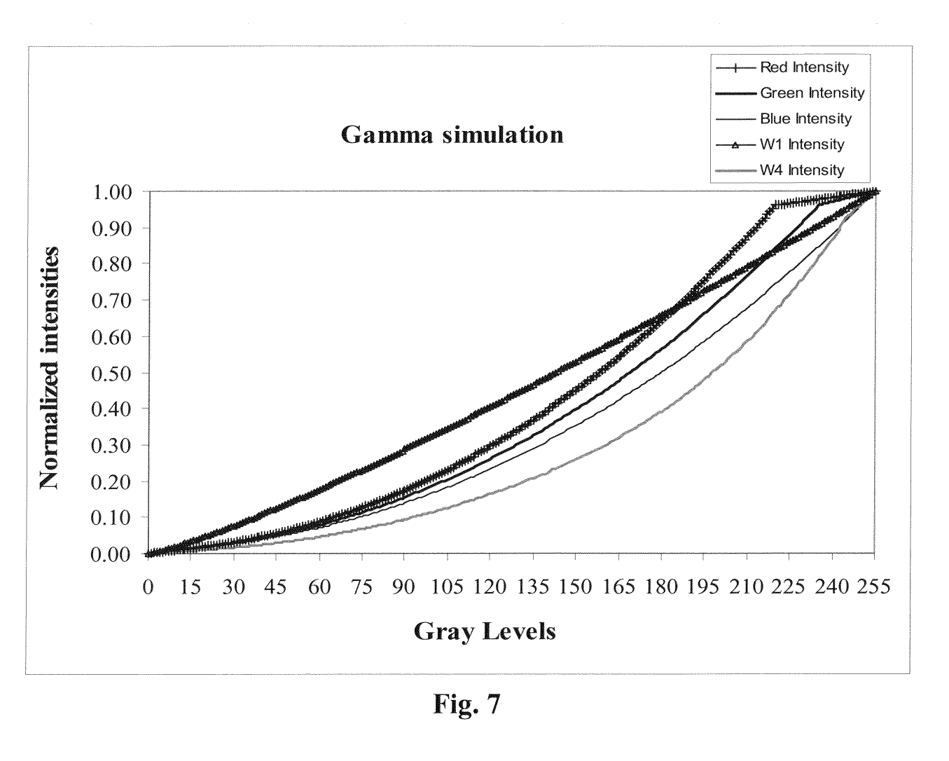

FIG. 7 is a simplified plot of normalized intensity as a function of gray level according to an embodiment of the present invention. The intensity of the various components as measured on the screen is plotted as the gray level applied to the display. As will be evident to one of skill in the art, the techniques described herein are also applicable to other display systems.

Referring to FIG. 7, for some of the components (e.g., red), the intensity saturates at high levels, whereas for other components (e.g., blue), the behavior is closer to a quadratic function. As illustrated by the references R′, G′, and B′ in FIG. 7, gamma correction is performed after brightness enhancement and color correction as described above. As a result, a faster progression for the primary colors and increases in the color saturation of the primary colors in comparison to the white level signal can be provided after other image processing techniques are performed as described herein. As an example, an implementation may utilize α=0.5, m=1.2, gamma correction for R, G, B=2.2, and gamma correction for W₁=1. For this particular example, the composite white gamma resulting from the sum of the various components (e.g., R′+G′+B′+W₁), referred to as W₄, is 2.5 as illustrated in FIG. 7.

Therefore, utilizing the methods and systems described herein, customized gamma correction is provided at the display level for each of the primary colors and the white level signal. Combined with the ability to adjust the threshold and slope of the curves defining the addition of the white level signal as well as the control of the color correction amplitude, embodiments of the present invention provide images with higher satisfaction levels than conventional techniques.

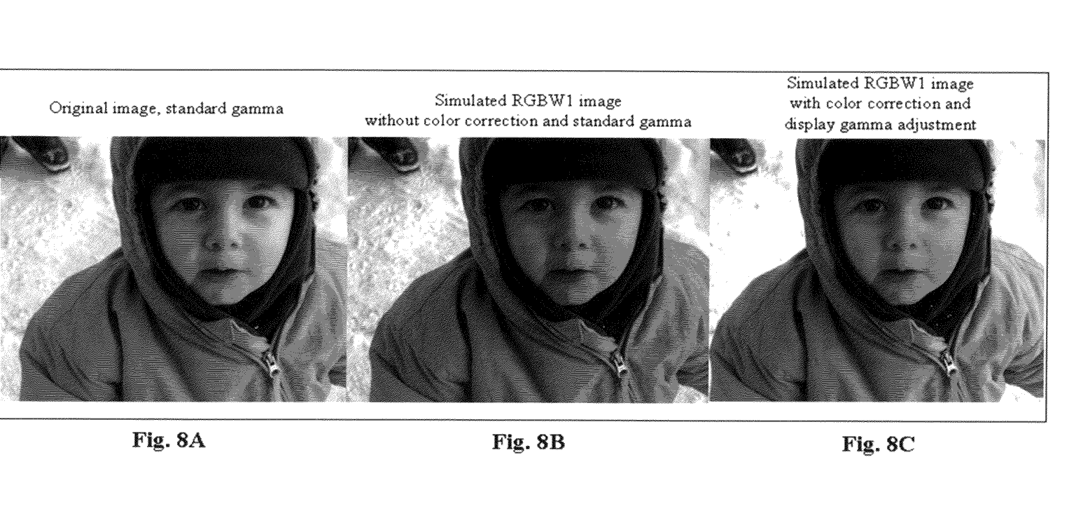

Since embodiments of the present invention provide adjustments that increase image brightness, provide for color correction, and additionally utilize post-processing display calibration to further increase primary color saturation, it is possible to achieve realistic display of skin tones as well as high color saturation in most scenes. FIGS. 8A-8C illustrate results of the simulation of exemplary skin tones according to an embodiment of the present invention.

The original RGB image is presented in FIG. 8A along with two images processed according to embodiments of the present invention. FIG. 8B illustrates an image for which α=0 so that the image includes RGB components as well as a white level signal added to increase image brightness, but with no color correction or calibration of the display as described with reference to FIG. 7. FIG. 8C illustrates an image for which m=1.2 and α=1.0. Thus, the image illustrated in FIG. 8C was produce using a process that utilized a white level signal to increase image brightness, performed color correction, and performed calibration of the display as described with reference to FIG. 7. Examining FIGS. 8A-8C, it is clear that embodiments of the present invention provide methods and systems to enhance image brightness while preserving realistic skin tones.

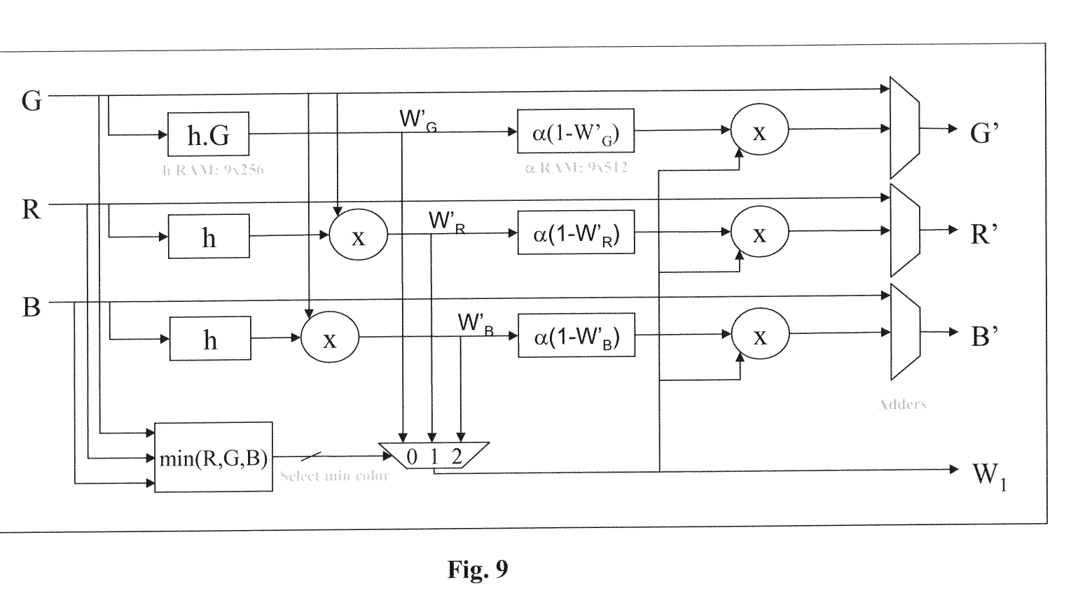

FIG. 9 is a simplified schematic diagram illustrating an implementation of an embodiment of the present invention. The implementation illustrated in FIG. 9 utilizes

FPGA logic, although this is not required by embodiments of the present invention. Referring to FIG. 9, the h(x) function defined in equation (1) is efficiently implemented with a lookup table in programmable logic, for example, a Xilinx FPGA. As an example, look-up tables (LUTs) utilize a distributed RAM structure. Since dual-port RAMs are readily available in FPGA and ASIC flows, it is possible to extract /r(R) and h(B) from one dual-port LUT stored in memory, thus saving at least one memory. The h(G) function has a different structure as described below.

The h(min(R, G, B)) function shown in equation (1) is implemented in FIG. 9 as min[h(R), h(G), h(B)] since all three h(x) functions are also needed for color correction. Thus, the implementation illustrated in FIG. 9 avoids having to build an additional LUT for h(min(R, G, B)). In order to save resources and also help meet throughput requirements, the min(R, G, B) function is performed in an embodiment with only two successive comparisons, instead of three parallel comparisons. For example, min(R, B) is performed in one cycle; then this result is compared with pipelined-G in the following cycle.

The scaling factor utilized in equation (2) utilizes a multiplier to modulate the h(x) functions by the normalized green component, which, as discussed above, is the dominant contributor to brightness. Since h(G) already uses a lookup table, the multiplier function is built in to the h(G) lookup, thereby saving a separate multiplier. The implementation of equation (4) is accomplished using three separate distributed LUTs.

Embodiments of the present invention perform color space computations in the RGB 8-bit gamma-encoded domain, thereby providing cost-effective controller implementation.

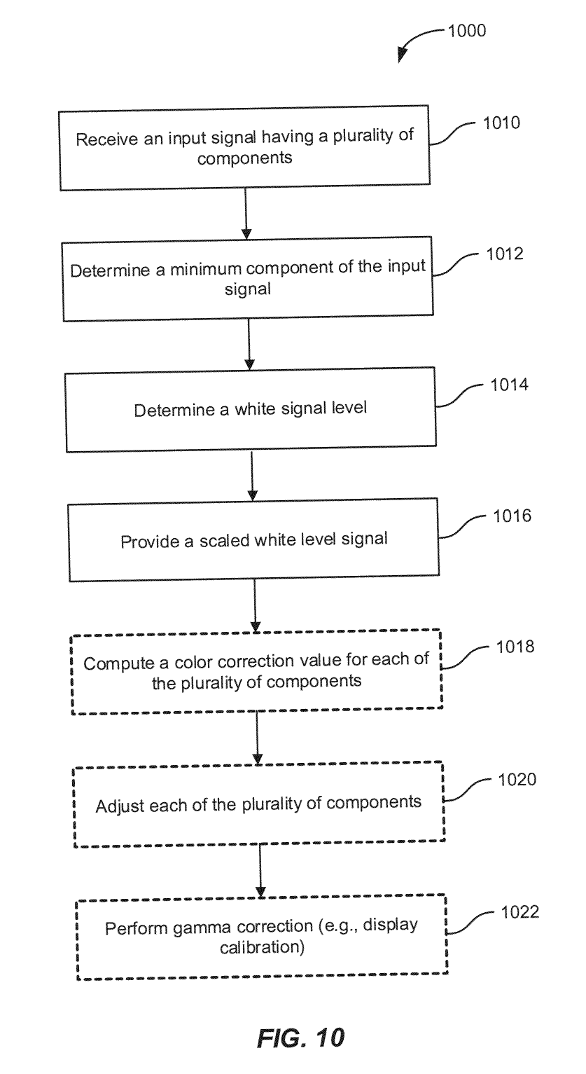

FIG. 10 is a simplified flowchart illustrating a method of processing an image according to an embodiment of the present invention. The method 1000 includes receiving an input signal associated with an input image (1010). The input signal has a plurality of components, for example, red, green, and blue. Other embodiments utilize input signals other than RGB, for example, RGBY or RGBYC. The method also includes determining a minimum component of the plurality of components (1012) and determining a white signal level as a function of the minimum component (1014). In some embodiments, the white signal level is determined using a function that is characterized by a threshold and a slope. The slope is generally linear, although other slopes are included within the scope of embodiments of the present invention.

The method further includes multiplying the white level signal by a normalized component of the plurality of components to provide a scaled white signal level (1016). In a specific embodiment, the normalized component is the green component scaled by a maximum intensity level (e.g., 255, 511, or the like). Because human eyes are most sensitive to green, the green component serves as a proxy for the brightness of the image. Thus, scaling by a value related to the brightness is performed with reduced complexity compared to use of a more accurate brightness value.

Additionally, the method optionally includes computing a color correction value for each of the plurality of components (1018), optionally adjusting each of the plurality of components by subtracting the color correction value from each of the plurality of components to provide adjusted components (i.e., R′, G′, B′) (1020) , and optionally performing gamma correction (also referred to herein as display calibration as described in reference to FIG. 7) (1022). The output image provided after performing the steps illustrated in FIG. 10, for example, a signal with components R′, G′, B′, W₁, provides both brightness adjustment, color correction, and independent gamma correction for each of the components and the white level signal to increase color saturation in some embodiments.

It should be appreciated that the specific steps illustrated in FIG. 10 provide a particular method of processing an image for display applications according to an embodiment of the present invention. Other sequences of steps may also be performed according to alternative embodiments. For example, alternative embodiments of the present invention may perform the steps outlined above in a different order. Moreover, the individual steps illustrated in FIG. 10 may include multiple sub-steps that may be performed in various sequences as appropriate to the individual step. Furthermore, additional steps may be added or removed depending on the particular applications. One of ordinary skill in the art would recognize many variations, modifications, and alternatives.

It will be appreciated that although embodiments of the present invention have been described with respect to applications including displays utilized in projection displays, embodiments are not limited to these particular applications. Other display applications including LCD panels, LCD projection systems, multi-chip projection systems, plasma displays, and the like are included within the scope of embodiments of the present invention. One of ordinary skill in the art would recognize many variations, modifications, and alternatives.

While the present invention has been described with respect to particular embodiments and specific examples thereof, it should be understood that other embodiments may fall within the spirit and scope of the invention. The scope of the invention should, therefore, be determined with reference to the appended claims along with their full scope of equivalents.

1-10. (canceled)

11. An apparatus configured to perform image processing, the apparatus comprising:
a plurality of input ports configured to receive a plurality of components of an image;
a first look-up table configured to provide a function of a first component of the plurality of components;
a second look-up table configured to provide functions of a second and a third component;
a processor coupled to the plurality of input ports and configured to compute a minimum of the plurality of components;
a plurality of color correction look-up tables, wherein each of the plurality of color correction tables is configured to perform color correction for each of the plurality of components;
a plurality of adders coupled to the plurality of color correction look-up tables and the plurality of input ports;
a plurality of output ports coupled to the adders and configured to output adjusted components; and
a selector coupled to the processor and configured to output a white level signal.

12. The apparatus of claim 11 wherein the plurality of components comprise red, green, and blue.

13. The apparatus of claim 12 wherein the plurality of components further comprise at least one of yellow and cyan.

14. The apparatus of claim 11 wherein the second look-up table comprises a dual port RAM.

15. The apparatus of claim 14 further comprising a set of multipliers coupled to the dual port RAM.

16. The apparatus of claim 11 wherein the processor is configured to perform a multi-step comparison process.

17. The apparatus of claim 11 further comprising a plurality of multipliers, each of the plurality of multipliers being coupled to each of the plurality of color correction look-up tables.

18. An apparatus for processing an RGB image, the apparatus comprising:
a green input port configured to receive a green component of the RGB image;
a red input port configured to receive a red component of the RGB image;
a blue input port configured to receive a blue component of the RGB image; a first look-up table coupled to the green input port;
a second look-up table coupled to the red input port and the blue input port;
a processor coupled to the green input port, the red input port, and the blue input port, wherein the processor is configured to compute a minimum of the green component, the red component, and the blue component;
a set of multipliers coupled to the second look-up table and to the green input port;
a selector coupled to the first look-up table and the set of multipliers, wherein the selector is configured to receive the minimum of the green component, the red component, and the blue component as an input and output a white level signal;
a green color correction look-up table coupled to the first look-up table;
a red color correction look-up table coupled to a first multiplier of the set of multipliers;
a blue color correction look-up table coupled to a second multiplier of the set of multipliers;
a second set of multipliers, wherein each of the second set of multipliers is coupled to one of the green, red, or blue color correction look-up tables and the white level signal; and
a set of adders, wherein each of the adders is coupled to one of the second set of multipliers and one of the green, red, or blue input ports.

19. The apparatus of claim 18 wherein the second look-up table comprises a dual port RAM.

20. The apparatus of claim 18 wherein the processor is configured to perform a multi-step comparison process.

21. The apparatus of claim 18 wherein the processor is configured to utilize a function including a threshold and slope.

22. The apparatus of claim 18 wherein the green, red, and blue color correction tables utilize a color correction amplitude.
